(19) United States
(12) Patent Application Publication
(10) Pub. No.: US 2026/0194386 A1
(43) Pub. Date: Jul. 9, 2026

(54) PLUMBING ALARM SYSTEM

(71) Applicants: Brenden Walker, Hamilton (CA); Kevin Walker, Hamilton (CA); David Alderson, Hamilton (CA); Dayna Walker, Hamilton (CA)

(72) Inventors: Brenden Walker, Hamilton (CA); Kevin Walker, Hamilton (CA); David Alderson, Hamilton (CA); Dayna Walker, Hamilton (CA)

(21) Appl. No.: 19/013,312

(22) Filed: Jan. 8, 2025

(51) Int. Cl. G01F 23/60; E03C 1/122; G01F 23/00

(52) U.S. Cl. CPC G01F 23/603; E03C 1/1222; G01F 23/0007; G08B 21/20

(57) ABSTRACT

A plumbing alarm apparatus that is configured to be installed in plumbing locations such as but not limited to floor drains and clean-out valves wherein the present invention provides an alarm to a user that the water level is above a desired level. The alarm includes a mounting rod wherein the mounting rod is journaled into a plumbing location. Secured to the mounting rod within the plumbing location is a sensor assembly. The sensor assembly is configured to transmit an alarm signal to a smart phone or provide an audio alert upon detection of rising water. A switch member is operably coupled to the sensor assembly and is operated via a float member. The float member traverses upwards in the presences of rising water wherein upon an unacceptable level of water the switch member activates the sensor assembly.

### FIELD OF THE INVENTION

The present invention relates generally to plumbing accessories, more specifically but not by way of limitation, an alarm device that is operably installed in a plumbing drain or a clean-out valve wherein the present invention provides an alert signal to a user of a drainage issue that could cause unwanted flooding.

### BACKGROUND

Flooding in a basement is a common but significant issue that homeowners face. It is a problem that can cause extensive damage, create health hazards, and lead to substantial financial losses. Therefore, understanding the importance of preventing basement flooding is essential for maintaining the safety, integrity, and value of a home. Basement flooding can result in severe structural damage to a home. Water infiltration weakens the foundation over time, compromising the stability of the entire structure. Cracks in walls and floors may appear, and in extreme cases, the foundation can shift or settle unevenly, leading to costly repairs. Preventing flooding ensures that the home remains structurally sound, safeguarding the significant financial investment homeowners make in their property. Another critical reason to prevent basement flooding is the potential health risks it poses. Standing water and excess moisture create the perfect environment for mold and mildew growth. These fungi release spores that can exacerbate respiratory conditions such as asthma and allergies. Additionally, flooded basements may harbor bacteria and other pathogens, particularly if the water originates from a sewage backup. By taking steps to prevent flooding, homeowners can protect their families from these health hazards and maintain a safe living environment.

Furthermore, basement flooding often leads to the loss of personal belongings and valuables stored in the affected area. Furniture, electronics, documents, and sentimental items can be irreparably damaged by water exposure. Insurance claims for such losses can be time-consuming and may not fully cover the emotional and financial costs of replacement. Proactively addressing flooding risks helps to preserve these items and prevents unnecessary hardship. Preventing basement flooding also contributes to environmental sustainability. Floodwater often contains pollutants that can seep into the soil and local water systems, harming the surrounding ecosystem. By ensuring proper drainage and implementing flood prevention measures, homeowners can reduce their environmental impact and promote healthier communities. Practical measures to prevent basement flooding include maintaining gutters and downspouts to ensure proper water flow away from the foundation, installing a sump pump to remove excess water, and waterproofing basement walls and floors. Regular inspections of plumbing systems and the grading around the home are also essential to identify potential vulnerabilities. For homes in flood-prone areas, investing in a backwater valve and creating an emergency preparedness plan are prudent steps to mitigate risks.

Preventing basement flooding is a crucial responsibility for homeowners. It protects the structural integrity of the home, safeguards the health of its occupants, and preserves valuable personal belongings. Additionally, it contributes to environmental preservation and reduces the financial burden associated with water damage. By implementing preventative measures and remaining vigilant, homeowners can ensure a safer and more secure living environment for themselves and their families. Furthermore, there is a need for additional devices that can provide automated monitoring of water levels in plumbing areas such as but not limited to floor drains and clean-out valves that can provide early notice to users of a potential flooding situation.

Accordingly, there is a need for an alert device that is communicably coupled to a smart phone, wherein the present invention provides monitoring of the water level within a floor drain or clean-out valve and provides transmission of a warning signal upon detection of standing water therein.

### SUMMARY OF THE INVENTION

It is the object of the present invention to provide a plumbing alert system that provides an alert of standing water in plumbing locations wherein the present invention includes a float switch that is movable between a first location and a second location.

Another object of the present invention is to provide a system configured to be operably installed in a floor drain or clean-out valve of a plumbing system wherein the present invention includes a sensor mounted above the normal water line.

A further object of the present invention is to provide a plumbing alert system that provides an alert of standing water in plumbing locations wherein the sensor is communicably coupled to a smart phone.

Yet a further object of the present invention is to provide a system configured to be operably installed in a floor drain or clean-out valve of a plumbing system wherein the present invention utilizes magnets to provide initiation of an alarm signal.

Still another object of the present invention is to provide a plumbing alert system that provides an alert of standing water in plumbing locations wherein the floor drain embodiment and the clean-out embodiment of the present invention includes an adjustable mounting rod.

An additional object of the present invention is to provide a system configured to be operably installed in a floor drain or clean-out valve of a plumbing system wherein both embodiments of the present invention utilize connection of a first magnet and a second magnet to initiate transmission of an alert signal.

Yet a further object of the present invention is to provide a plumbing alert system that provides an alert of standing water in plumbing locations wherein the clean-out embodiment of the present invention includes a second magnet operably coupled to a floating member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the floor drain embodiment of the present invention; and

FIG. 2 is a diagrammatic view of the clean-out embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a plumbing alarm apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

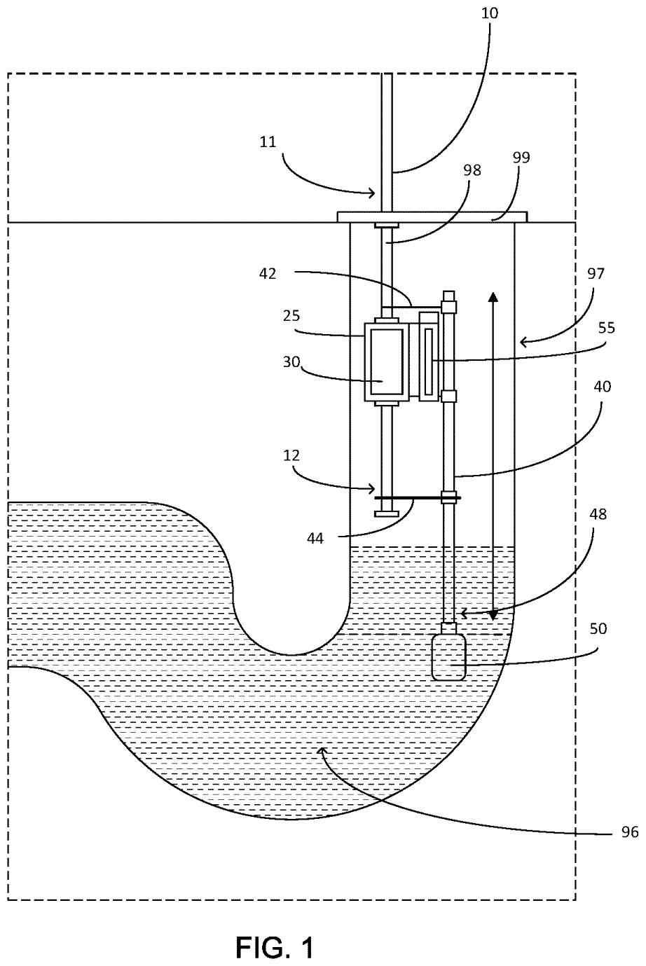

Referring in particular to the Figures submitted herewith, the plumbing alarm apparatus 100 is illustrated herein in FIG. 1 in a floor drain embodiment. It should be understood within the scope of the present invention that the plumbing alarm apparatus 100 is configured to be installed in a floor drain in an exemplary location such as but not limited to a basement. The plumbing alarm apparatus 100 includes a mounting rod 10 wherein the mounting rod 10 is manufactured from a durable material such as but not limited to metal. The mounting rod 10 includes a first end 11 and second end 12. The mounting rod 10 is operably coupled to drain cover member 99 utilizing keeper 98. It should be understood that the mounting rod 10 is configured to be trimmed or severed proximate the drain cover member 99 ensuing installation of the plumbing alarm apparatus 100.

The mounting rod 10 extends inward into the drain 97 and has operably coupled thereto a sensor mount 25. Sensor mount 25 is operably coupled to the mounting rod 10 utilizing suitable durable techniques. Operably coupled to the sensor mount 25 is sensor assembly 30. Sensor assembly 30 includes the necessary electronics to receive, store, transmit and manipulate data. The sensor assembly 30 is communicably coupled to a smart phone(not illustrated herein) and is operable to transmit a signal thereto utilizing suitable wireless communication protocols. It is further contemplated within the scope of the present invention that the sensor assembly 30 could be configured with an audio emitting device so as to emit an audio signal once the sensor assembly 30 has been activated. It should be understood within the scope of the present invention that the sensor assembly 30 includes a power supply such as but not limited to a replaceable battery to provide the operation thereof as described herein.

Movably coupled to the mounting rod is float rod 40. Float rod 40 is operably coupled to the mounting rod 10 utilizing upper support member 42 and lower support member 44. Upper support member 42 and lower support member 44 are slidably secured to the mounting rod 10 being perpendicular thereto extending outward therefrom. The upper support member 42 and lower support member 44 are parallel in configuration. The float rod 40 has secured to the second end 48 thereof a float member 50. The float member 50 is manufactured from foam plastic or other buoyant material. The float member 50 is configured to move in an upwards direction upon the presence of water in the trap area 96 of the drain. The float member 50 moves upward driving the float rod 40 upwards changing the position of the switch member 55. If a sufficient level of water is present in the trap area 96, the switch member 55 is moved to a position such that the switch member 55 is parallel to the sensor assembly 30. Subsequent the switch member 55 being parallel to the sensor assembly 30, the sensor assembly 30 provides activation of an alarm signal so as to indicate a presence of water that exceeds a desire amount which may lead to flooding. It is contemplated within the scope of the present invention that the switch member 55 could be constructed of various suitable elements operable to activate the sensor assembly 30. By way of example but not limitation, the switch member 55 could be manufactured from magnets.

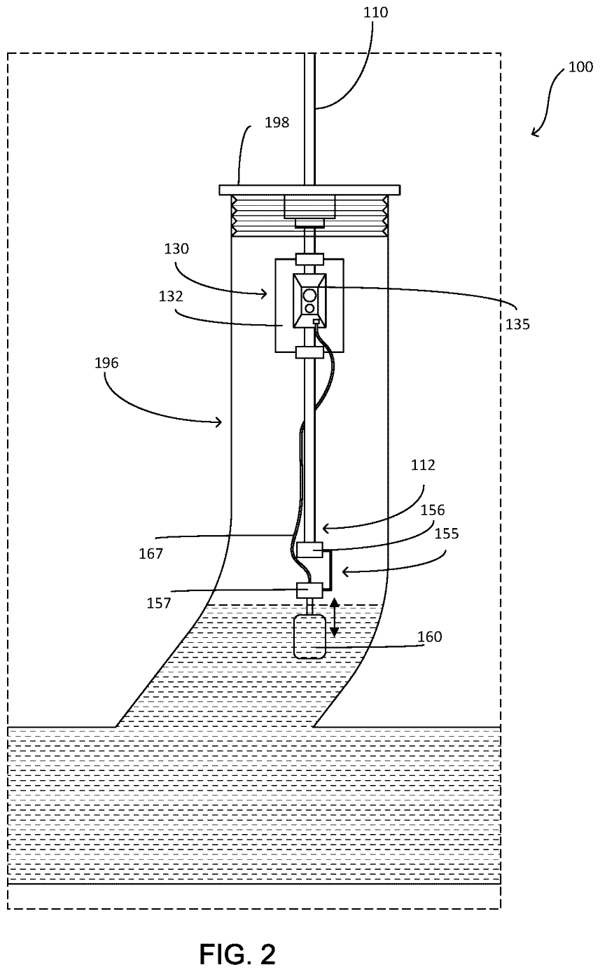

Referring now to FIG. 2, the clean-out valve embodiment of the plumbing alarm apparatus 100 is illustrated therein. The embodiment illustrated in FIG. 2 includes a mounting rod 110 wherein the mounting rod 110 is journaled through the cover member 198. Mounting rod 110 is manufactured from a rigid material having a first end 111 and a second end 112. The mounting rod 110 is configured to have the first end 111 trimmed ensuing installation thereof wherein the first end 111 does not extend past the cover member 198. Secured to the mounting rod 110 within the void 105 of the exemplary clean-out valve 196 is the sensor assembly 130. The sensor assembly 130 includes mounting member 132 having sensor 135 secured thereto. The mounting member 132 is fixedly secured to the mounting rod 110 utilizing suitable durable techniques. The sensor 135 includes the necessary electronics to receive, store, transmit and manipulate data. The sensor assembly 130 is communicably coupled to a smart phone(not illustrated herein) and is operable to transmit a signal thereto utilizing suitable wireless communication protocols. It is further contemplated within the scope of the present invention that the sensor 135 could be configured with an audio emitting device so as to emit an audio signal once the sensor 135 has been activated. It should be understood within the scope of the present invention that the sensor assembly 130 includes a power supply such as but not limited to a replaceable battery to provide the operation thereof as described herein.

The sensor 135 is operably coupled to switch assembly 155. Switch assembly 155 includes a first portion 156 and a second portion 157. First portion 156 is secured to the second end 112 of the mounting rod 110 utilizing suitable durable techniques. The second portion 157 is operably coupled to float member 160. Float member 160 is manufactured from a suitable buoyant material. The float member 160 is configured to move upwards ensuing engagement with water at a level that is higher than a normally acceptable limit in clean-out valve 196. Subsequent operable coupling of the first portion 156 and second portion 157, the circuit of the switch assembly 155 is closed transmitting current to the sensor 135 via wire 167 providing activation thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A plumbing alarm apparatus that is configured to be operably disposed within a plumbing system wherein the plumbing alarm apparatus comprises:
a mounting rod, said mounting rod having a first end and a second end, said mounting rod being rod shaped and rigid being vertical in orientation, said mounting rod extending into an area within the plumbing system;
a sensor assembly, said sensor assembly having electronics configured to receive, transmit, store and manipulate data, said sensor assembly configured to provide an alert signal subsequent a water level in the area of the plumbing system exceeding a desired level;
a switch assembly, said switch assembly being operably coupled with said sensor assembly, said switch assembly operable to provide activation of said sensor assembly; and
a float member, said float member being operably coupled to said switch assembly, said float member configured traverse upwards in a presence of water above the desired level in order to provide activation of said switch assembly.

2. The plumbing alarm apparatus that is configured to be operably disposed within a plumbing system as recited in claim 1, wherein said switch assembly further includes a first portion and a second portion, said first portion being secured to said second end of said mounting rod, said second portion being operably coupled to said float member.

3. The plumbing alarm apparatus that is configured to be operably disposed within a plumbing system as recited in claim 2, wherein said second portion of said switch assembly is configured to operably engage with said first portion subsequent said float member traversing upwards providing contact of said second portion to said first portion.

4. The plumbing alarm apparatus that is configured to be operably disposed within a plumbing system as recited in claim 1, wherein said float member is operably coupled to a float rod, said float rod extending upward from said float member, said float rod being parallel to said mounting rod.

5. The plumbing alarm apparatus that is configured to be operably disposed within a plumbing system as recited in claim 4, wherein said float rod further includes an upper support member and a lower support member, said upper support member and said lower support member being parallel, said upper support member and said lower support member being perpendicular to said float rod, said upper support member and said lower support member being operably coupled to said mounting rod and slidably engaged therewith.

6. The plumbing alarm apparatus that is configured to be operably disposed within a plumbing system as recited in claim 5, wherein said float rod further includes a portion of the switch assembly, said portion being operably coupled with said switch assembly upon being proximate thereto.

7. The plumbing alarm apparatus that is configured to be operably disposed within a plumbing system as recited in claim 6, wherein said portion of the switch assembly secured to said float rod is movable in an upwards-downwards motion driven by said float rod.

8. The plumbing alarm apparatus that is configured to be operably disposed within a plumbing system as recited in claim 7, wherein said sensor assembly provides an alert signal upon water presence beyond the desired level.
